(19) United States
(12) Patent Application Publication
(10) Pub. No.: US 2007/0019962 A1
(43) Pub. Date: Jan. 25, 2007

(54) Infrated transceiver module that can adjust its transmitting and receiving angle automatically

(75) Inventors: Yu-Chi Lin, Sinjhuang City (TW); Beniz Wang, Banciao City (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Inventec Corporation, Taipei (TW)

(21) Appl. No.: 11/187,428

(22) Filed: Jul. 22, 2005

(51) Int. Cl. H04B 10/00

(52) U.S. Cl. 398/135

(57) ABSTRACT

An infrared transceiver module that can automatically adjust its transmitting and receiving angle is provided. The module is to be mounted on the fixed seats of computer motherboards, interface cards, add-on signal receivers, or remote control devices etc. It comprises an infrared transceiver and a housing unit which further comprises a hanging weight attached to the housing unit through its bottom by a connecting rod and forming a 90 degree angle with the transmitting and receiving direction of the infrared transceiver. The housing unit contains an axle which is placed on an axle seat and can be rolled forward and backward freely that when the notebook computer is not placed level, the hanging weight will, by way of gravity, remain vertical to level, thereby pulling the transmitting and receiving direction of the infrared transceiver back to level.

### BACKGROUND OF THE INVENTION

1. Field of the Invention

The present invention relates to an infrared transceiver module that is to be mounted on computer motherboards, interface cards, add-on signal receivers, or remote control devices etc., particularly one that, when the notebook computer is not placed level, can automatically adjust its transmitting and receiving angle, bringing the transmitting and receiving direction of the infrared transceiver back to level by way of the gravity exerted by a hanging weight.

2. Description of Related Art

As far as notebook computers are concerned, aside from using such traditional means as CDs, floppy disks, or the internet, the transmission of electronic data can also be done through infrared transmission. By making use of the wave length of the infrared ray as the medium for data transmission, the computer can dispense with those annoying cables, greatly improving its mobility. As such, infrared transmission has, nowadays, become a required feature of most notebook computers.

Currently, the common practice with most notebook computers is to place the infrared transceiver inside the notebook computer's main body (the casing that host the motherboard, the hard disk . . . etc., ) When a notebook computer needs to do data transmission jobs with another electronic device (such as a wireless printer, wireless mouse, or any other remote control device) with similar standard infrared transmitting and receiving capacity, the user has to position the infrared transceiving windows of the two machines, letting one face the other, and make sure that each is within the infrared transceiving range of the other so that the transmitting and receiving of data can be both accurate and complete. Please refer to FIG. 1A and FIG. 1B. Most conventional infrared transceivers are stationed in their hosting notebook computers' main bodies, with fixed foundation facing permanently forward. As the transceiving angle of the infrared transceiver is just a conical range of approximately

15 degrees, blind spots abound where reception is difficult or incomplete, particularly when the two devices to transmit and receive data are relatively far apart that even slight slanting of one of them can cause the two machine's transceiving ranges to misalign, resulting in unsuccessful or incomplete data transmission. Of course, the user can re-position the two machines trying to align the two transceiving ranges, but it is a patience-trying process that often causes mistrust of the equipment on the part of the user.

### SUMMARY OF THE INVENTION

To solve the above problems confronting the conventional infrared transceiving devices, the applicant has spent years experimenting on various concepts for a better infrared transceiver structure and finally come up with the present invention.

The object of the present invention is to provide an infrared transceiver module that can automatically adjust its transmitting and receiving angle to solve the often seen transceiving problem when the notebook computer and a remote control device are not placed level, resulting in the misalignment of both devices' infrared transceiving angle, causing unsuccessful or incomplete transmission.

To achieve the object the present invention introduces a new design that incorporates an infrared transceiver and a housing unit which further comprises a hanging weight attached to the housing unit through its bottom by a connecting rod and forming a fixed transmitting and receiving angle with the infrared transceiver. The housing unit contains an axle which is placed on an axle seat and can be rolled forward and backward freely that when the notebook computer is not placed level, the hanging weight will, by way of gravity, remain vertical to level, thereby pulling the transmitting and receiving direction of the infrared transceiver back to level. Thus, the conventional headache of having to adjust and re-adjust the positions of the two devices transmitting and receiving data is eliminated.

### BRIEF DESCRIPTION OF THE DRAWINGS

FIG. 1A shows how the transceiving angle of a conventional infrared transceiver can be out of level;

FIG. 1B shows how the transceiving angle of another conventional infrared transceiver can be out of level;

FIG. 2 shows how the present invention can be embodied;

FIG. 3 shows the three dimensional close-up view of the present invention;

FIG. 4 shows the three dimensional close-up view of the hanging weight of the present invention; and

FIG. 5 shows how two pieces of equipment, made in accordance with the spirit of the present invention, work in regard to data transmission.

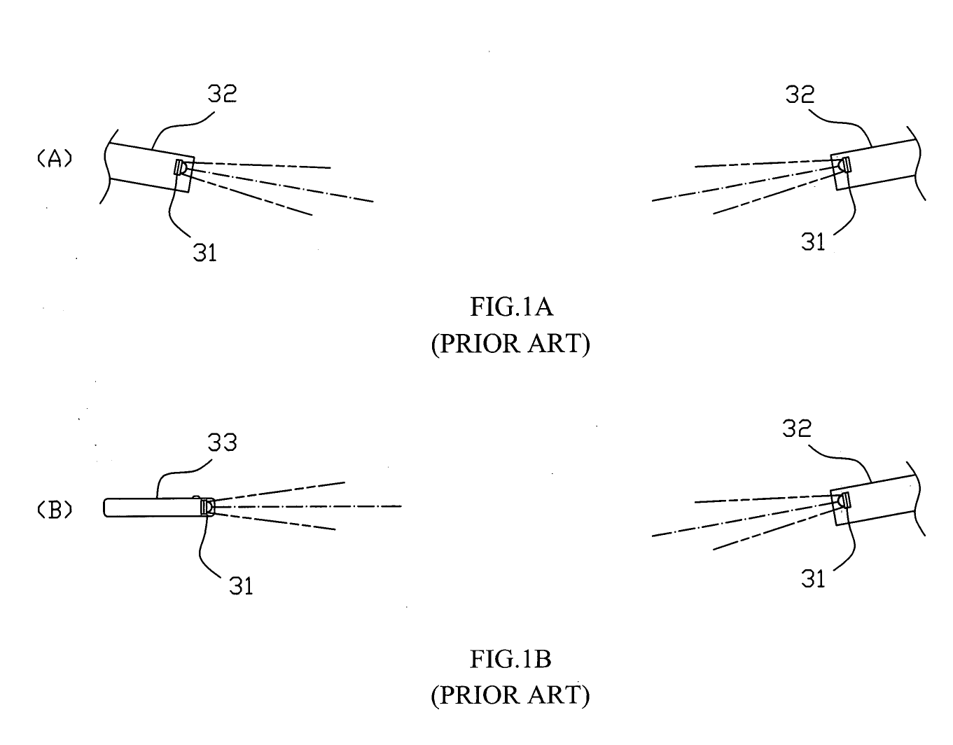

### DESCRIPTION OF THE PREFERRED EMBODIMENTS

To get better understand the structure, features, functions and advantages of the present invention, we shall present a detailed description of some preferred embodiments, aided with illustrations, in the following.

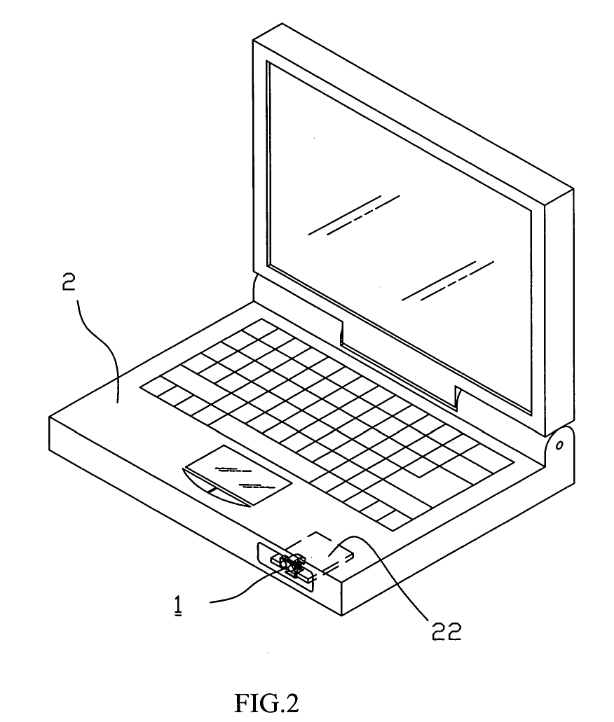

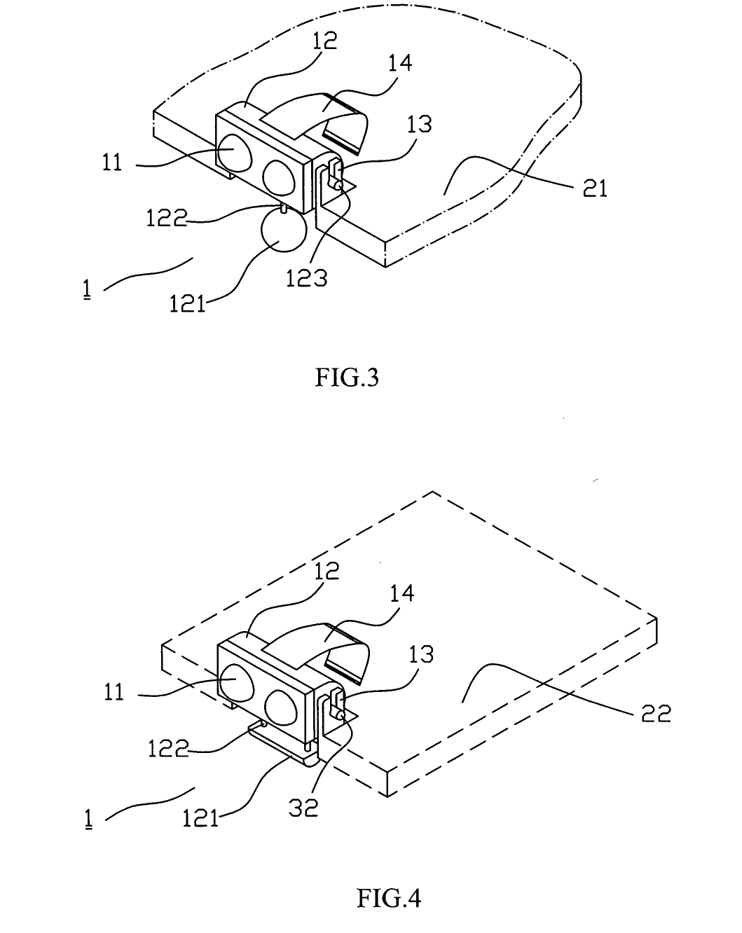

Please refer to FIG. 2 to FIG. 4. The infrared transceiver module 1 can automatically adjust its transmitting and receiving angle. The infrared transceiver module 1 is to be mounted on the fixed seat 13 of the motherboard 21 of a notebook computer 2 or an infrared transmitting and receiving interface card 22. The infrared transceiver module 1 comprises an infrared transceiver 11 and a housing unit 12. The infrared transceiver 11 is a conventional component placed inside the housing unit 12 and is connected with the motherboard 21 or the interface card 22 by a data transmission cable 14 to transmit or receive data signals according to the commands from the computer. The housing unit 12 comprises a hanging weight 121 and an axle 123, wherein the hanging weight 121 is an object with considerable weight and is attached to the housing unit 12 through its bottom by a connecting rod 122, forming a 90 degree angle with the transmitting and receiving direction of the infrared transceiver 11. The axle 123 is set on the two sides of the housing unit 12 and can be placed on the fixed seat 13 of the motherboard 21 or the interface card 22. Also, the axle 123 can be rolled forward and backward freely but will not slip out. By this design, the hanging weight 121 will, by way of gravity, always remain vertical to level and that, when the notebook computer is not placed level, keep a fixed level angle for the transmitting and receiving direction of the infrared transceiver 11.

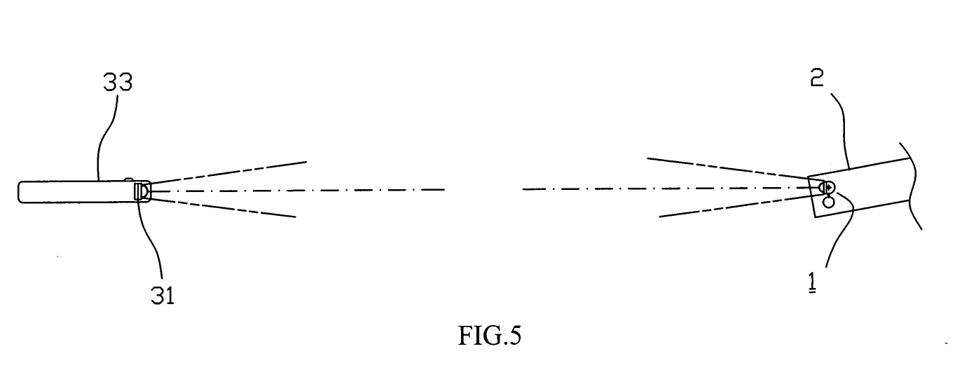

Now, please refer to FIG. 5. It is clear that even when a notebook computer 2 is not placed level, with the present invention's infrared transceiving module 1 as embodied above in it, the transmitting and receiving direction of its infrared transceiver will still be pulled back to level automatically, letting the infrared transceiving angle of the infrared transceiving module 1 and the infrared receiving device 31 match accurately, ensuring complete and successful data transmission between the two. In addition, the present invention can apply to add-on signal receivers of wireless keyboards or wireless mice, wireless printers and remote control devices 32 and so on, so users can easily transmit data between the two devices.

Although the present invention is disclosed as the preferred embodiment described in the above, the description is by no means meant to limit the scope of the invention's applications. As is understood by a person skilled in the art, the foregoing preferred embodiment of the present invention is an illustration, rather than a limiting description, of the present invention. It is intended to cover various modifications and similar arrangements included within the spirit and scope of the appended claims, the scope of which should be accorded the broadest interpretation so as to encompass all such modifications and similar structures.

What is claimed is:

1. An infrared transceiver module, to be mounted on a fixed seat in an electronic device, that can automatically adjust its transmitting and receiving angle, comprising
an infrared transceiver and a housing unit, wherein said infrared transceiver is placed in said housing unit which further comprises a hanging weight and an axle which is set on said fixed seat and can roll forward and backward freely; said hanging weight will, by way of gravity, remain vertical to level, thereby pulling the transmitting and receiving direction of said infrared transceiver to a fixed angle.

2. The infrared transceiver module as claimed in claim 1, wherein said electronic device is a computer motherboard.

3. The infrared transceiver module as claimed in claim 1, wherein said electronic device is an interface card.

4. The infrared transceiver module as claimed in claim 1, wherein said electronic device is an add-on signal receiving device.

5. The infrared transceiver module as claimed in claim 1, wherein said electronic device is a wireless printer.

6. The infrared transceiver module as claimed in claim 1, wherein said electronic device is a remote control device.

7. The infrared transceiver module as claimed in claim 1, wherein said hanging weight is attached to said housing unit through its bottom by a connecting rod.

8. The infrared transceiver module as claimed in claim 1, wherein said transmitting and receiving direction of said infrared transceiver remains a level angle.
